(19) United States
(12) Patent Application Publication
(10) Pub. No.: US 2018/0313460 A1
(43) Pub. Date: Nov. 1, 2018

(54) OPENING AND CLOSING VALVE

(71) Applicant: Koganei Corporation, Koganei-shi, Tokyo (JP)

(72) Inventors: Toshiaki Tsuchizawa, Koganei-shi, Tokyo (JP); Syuichi Hosaka, Koganei-shi, Tokyo (JP); Naoki Furuhashi, Koganei-shi, Tokyo (JP); Hirokazu Ohki, Koganei-shi, Tokyo (JP); Keisuke Matsumoto, Koganei-shi, Tokyo (JP)

(21) Appl. No.: 15/772,124

(22) PCT Filed: Nov. 11, 2015
(86) PCT No.: PCT/JP2015/081770

§ 371 Date: Apr. 30, 2018

(51) Int. Cl. F16K 31/06

(52) U.S. Cl. CPC F16K 31/0655; F16K 31/0672; F16K 31/0679

(57) ABSTRACT

An opening and closing valve (10) has a valve body (11) and a solenoid block (12), the valve body (11) having input ports (16a, 16b), an output port (17), and a valve seat (36), the solenoid block (12) having a fixed iron core (22), a movable element (41) being provided in a valve chamber (33), the movable element (41) being pushed onto the valve seat (36) by compressed air supplied to the valve chamber (33), wherein when driving current is supplied to the coil (21), the movable element (41) is separated from the valve seat (36), a concave portion (46) is provided to an opposite end surface (31), a sheet (47) made of resin and attached to the opposite end surface (31) covers a magnetic attraction surface (32) and the concave portion (46), the movable element (41) abutting on the magnetic attraction surface (32) via a coated layer (51) forming part of the sheet (47), the sheet (47) enters the concave portion (46) so as to form an air chamber (52).

### CROSS-REFERENCE TO RELATED APPLICATION

This application is a National Stage application of International Patent Application No. PCT/JP2015/081770, filed on Nov. 11, 2015, which is hereby incorporated by reference in its entirety.

### TECHNICAL FIELD

The present invention relates to an opening and closing valve that carries out a switching operation between an opened state that allows an input port and an output port to communicate with each other and a closed state that shut off the communication.

### BACKGROUND

In order to carry out a switching operation between a state in which compressed air is supplied to a specific member and a stopped state in which compressed air is not supplied to the specific member, an opening and closing valve is used. The opening and closing valve is provided with a valve body and a solenoid block that is assembled onto the valve body. The valve body is provided with: an input port connected to an air pressure supply source; an output port connected to the specific member; and a valve seat that serves as a partition between the input port and the output port. The solenoid block is provided with a fixed iron core around which a coil is wound, and a valve member constituted as a movable iron core is disposed in the valve body so as to face a magnetic attraction surface of the fixed iron core, that is, an attracting surface thereof. When it supplies electric power to the coil, the valve member is separated from the valve seat so that the input port is communicated with the output port, and when it stops supplying electric power to the coil, the valve member is made in contact with the valve seat so that the communication between the input port and the output port is shut off.

Japanese unexamined patent application publication No. 2014-137118 discloses an opening and closing valve in which the opening/closing stroke of the valve member is made smaller so that the opening/closing operation is carried out at high speed, and in this opening and closing valve, the valve member is directly made in contact with the magnetic attraction surface of the fixed iron core. An electromagnetic valve disclosed in Japanese unexamined patent application publication No. 2009-275811 is provided with a solenoid part having a fixed magnetic pole member and a movable iron core and a valve part provided with a valve member that carries out opening/closing operations by the movable iron core. A sheet-shaped impact buffering member is provided between the fixed magnetic pole member and the movable iron core, and the entire contact surface of the movable iron core is made in contact with the magnetic attraction surface of the fixed magnetic pole member with the interposed impact buffering member. Japanese patent No. 5502240 discloses an electromagnetic valve in which a film made of resin is bonded to the magnetic attraction surface of a fixed iron core.

### SUMMARY

As described in Japanese unexamined patent application publication No. 2014-137118, in the case when the movable iron core is directly made in contact with the magnetic attraction surface of the fixed iron core, the magnetic attraction surface is corroded by moisture contained in compressed air. As a result, the opening/closing operation characteristics of the movable iron core change with time. A material having good magnetic characteristics is used for the fixed iron core, and such a material tends to rust easily. For this reason, the durability of the opening and closing valve is hardly improved. Moreover, since the entire contact surface of the movable iron core is designed to be made in contact with the impact buffering member, as described in Japanese unexamined patent application publication No. 2009-275811, the movable iron core is hardly separated from the impact buffering member, when the electromagnetic valve is switched from the opened state to the closed state by stopping supplying driving current to the coil so as to separate the movable iron core from the impact buffering member. This is because since the entire contact surface of the movable iron core is made tightly in contact with the impact buffering member, air is hardly enter the gap between the entire contact surface of the movable iron core and the impact buffering member, even when it stops supplying driving current to the coil. Consequently, it is not possible to shorten the operation time of the closing operation of the movable iron core. Moreover, as described in Japanese patent No. 5502240, in a case where the resin sheet is bonded only to the magnetic attraction surface of the iron core, since an adhesive layer and a sheet layer are stacked on the magnetic attraction surface so that the magnetic attraction surface is covered with the stacked thick coated layers, the distance between the fixed iron core and the movable iron core becomes longer. In this case, since a strong magnetic force is required for attracting the movable iron core, the solenoid and the magnetic circuit need to have large sizes.

An object of the present invention is to provide an opening and closing valve improved in responsiveness of the movable iron core. In particular, the object is to shorten the closing operation time at the time of closing the valve seat by allowing the movable iron core to separate from the fixed iron core upon stopping a solenoid current.

Another object of the present invention is to provide an opening and closing valve that can improve its durability. In particular, the object is to prevent the magnetic attraction surface of the fixed iron core from being rusted and consequently to improve the durability.

In accordance with one aspect of the present invention, there is provided an opening and closing valve comprising: a valve body provided with a valve seat; a solenoid block that forms a valve chamber in cooperation with the valve body; an opposite end surface on which a magnetic attraction surface of a fixed iron core around which a coil is wound is provided, and which is provided to the solenoid block so as to face the valve body; a movable element provided in the valve chamber, wherein the movable element is attracted to the magnetic attraction surface when driving current is supplied to the coil; a concave portion that is provided to the opposite end surface, at least one portion thereof facing the movable element; and a sheet made of resin and attached to the opposite end surface so as to cover the magnetic attraction surface and the concave portion, wherein an air chamber is formed by the sheet and the concave portion.

In the opening and closing valve according to the present invention, since the magnetic attraction surface of the fixed iron core is covered with a sheet made of resin, the magnetic attraction surface is prevented from being corroded by moisture contained in compressed air. Thus, the opening operation time and closing operation time of a movable element can be maintained without a change for a long time. Consequently, the durability of the opening and closing valve can be improved. Moreover, when it stops supplying driving current to the coil, the movable element can be quickly driven toward the valve seat by compressed air inside an air chamber. Thus, the closing operation time in which the movable element is separated from the fixed iron core to close the valve seat is shortened. Moreover, since the sheet can be attached to the opposite end surface without using an adhesive, the thickness of the adhesive can be eliminated so that the distance between the movable element and the fixed iron core can be shortened. Therefore, a large magnetic force is not required for the coil so that it is not necessary to make the coil larger, thereby making it possible to downsize the opening and closing valve.

### BRIEF DESCRIPTION OF THE DRAWINGS

FIG. 1 is a partially exploded front view showing an opening and closing valve according to a first embodiment of the present invention;

FIG. 2 is a cross-sectional view taken along line A-A of FIG. 1;

FIG. 3 is a bottom view showing an opposite end surface of a solenoid block shown in FIG. 1;

FIG. 4 is a cross-sectional view taken along line B-B of FIG. 1;

FIG. 5(A) is a partially enlarged cross-sectional view showing a C-shaped portion of FIG. 1, and FIG. 5(B) is a bottom view showing a seal viewed from line D-D direction of FIG. 5(A);

FIGS. 6(A) to 6(D) are bottom views each showing a solenoid block as a modified example in which a concave portion 46 is provided to an opposite end surface 31;

FIG. 7 is a cross-sectional view showing a state in which a clearance is formed between a valve body and a solenoid block, and a sheet made of resin is disposed in this clearance;

FIG. 8(A) is a cross-sectional view showing a state in which the sheet made of resin is sandwiched between the valve body and the opposite end surface of the solenoid block, and FIG. 8(B) is a cross-sectional view showing a state in which compressed air is supplied to a valve chamber, with the sheet partially entering the concave portion;

FIG. 9(A) is a cross-sectional view showing a solenoid block and a forming mold, the sheet made of resin being in contact with the opposite end surface, and FIG. 9(B) is a cross-sectional view showing a state in which the sheet partially enters the concave portion by using the forming mold; and

FIG. 10(A) is a cross-sectional view showing the solenoid block a molding elastic member, the sheet made of resin being in contact with the opposite end surface, and FIG. 10(B) is a cross-sectional view showing a state in which the elastic member is pushed onto the sheet to make the sheet partially enter the concave portion.

### DETAILED DESCRIPTION

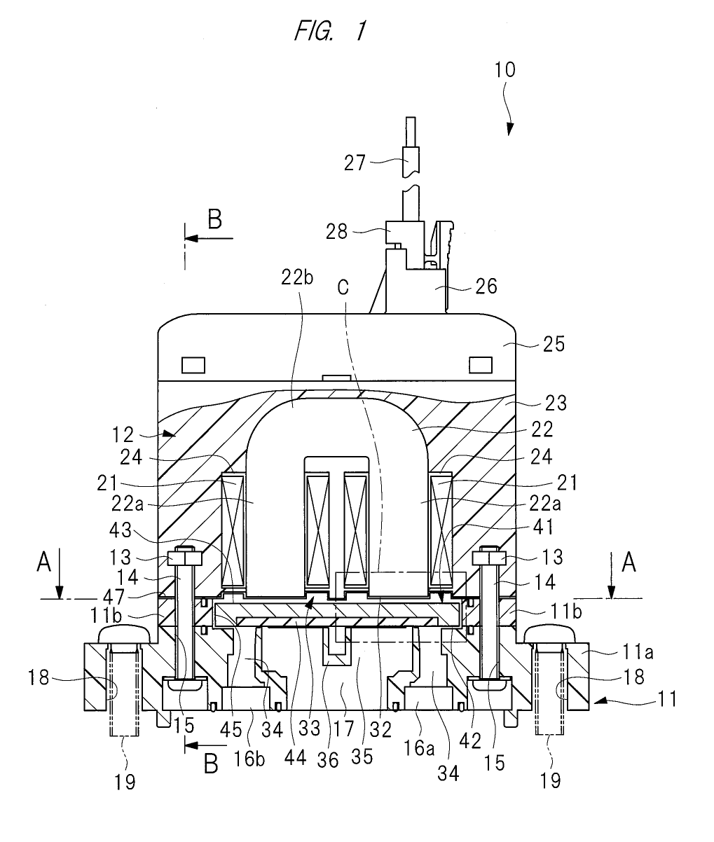

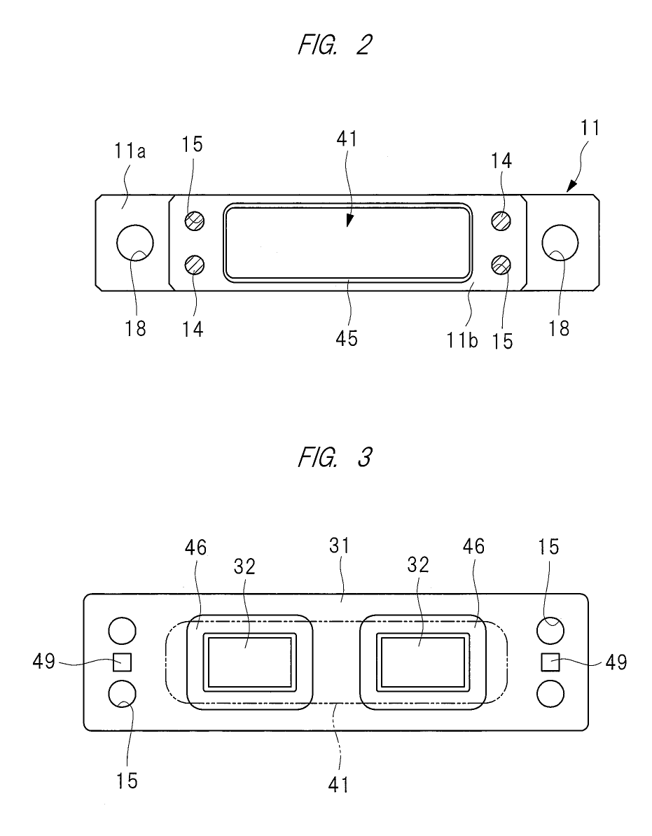

Hereinafter, embodiments of the present invention will be described in detail with reference to the accompanying drawings. As shown in FIG. 1, an opening and closing valve 10 is provided with a valve body 11 and a solenoid block 12. The valve body 11 is provided with a base part 11a and a spacer 11b, and is molded by resin. The valve body 11 is assembled onto the solenoid block 12. As shown in FIG. 2, the valve body 11 has an almost rectangular shape as a whole, and the lateral cross section of the solenoid block 12 also has an almost rectangular shape. In order to assemble the valve body 11 and the solenoid block 12, nuts 13 are provided inside the right and left two end parts of the solenoid block 12 in FIG. 1. Screw members 14 to be screw-connected with the nuts 13 are respectively inserted into through holes 15 provided to the base part 11a and the spacer 11b of the valve body 11. Additionally, the valve body 11 may be provided with a base part 11a integral with a spacer 11b. On the other hand, the screw members 14 may be prepared as tapping screws, and no nuts 13 are required in this case.

Two input ports 16a and 16b and an output port 17 are provided to the valve body 11, and the output port 17 is provided between the two input ports 16a and 16b. As shown in FIGS. 1 and 2, attaching holes 18 are respectively provided to two end parts of the valve body 11. By screw members 19 inserted into the respective attaching holes 18, the valve body 11 is attached to a support member (not shown). One or both the input ports 16a and 16b are connected to an air pressure supply source. On the other hand, the output port 17 is connected to a specific member (not shown) so that compressed air supplied from the input port to the specific member.

The solenoid block 12 is provided with a fixed iron core 22 around which a coil 21 is wound, and the coil 21 and the fixed iron core 22 are assembled into a case member 23 constituted by a seal member made of resin. The fixed iron core 22 is provided with: leg parts 22a that extend in parallel with each other; and a base part 22b that couples base end parts of the leg parts 22a with each other, and is formed into a U-letter shape. Bobbins 24 around which the coil 21 is wound are respectively attached to the leg parts 22a. A cover 25 is attached to the solenoid block 12, and a socket 26 is provided to the cover 25. A connector 28, which is provided with a cable 27 for use in feeding a driving current to the coil 21 from outside, is detachably attached to the socket 26.

The solenoid block 12 has an opposite end surface 31 that faces the valve body 11, and a magnetic attraction surface 32 (magnetically-attracting face) corresponding to the tip face of the fixed iron core 22 is exposed onto the opposite end surface 31. The valve body 11 and the solenoid block 12 that is assembled thereon cooperatively partition and form a valve chamber 33. The input ports 16a and 16b are communicated with the valve chamber 33 through an input flow path 34 formed in the valve body 11, and the output port 17 is communicated with the valve chamber 33 through an output flow path 35 formed in the valve body 11. The input ports 16a and 16b are communicated with the output port 17 through the valve chamber 33 so that compressed air that flows into the input ports 16a and 16b is supplied to the outside from the output port 17. A valve seat 36 is formed between the input flow path 34 and the output flow path 35, and the input ports 16a and 16b and the output port 17 are partitioned from each other by the valve seat 36. The valve seat 36 is provided to the valve body 11; however, these two members may be integrally formed, or may be formed as separated members.

As shown in FIGS. 1 and 2, a movable element 41 having a rectangular plate-shape and made of metal material is disposed inside the valve chamber 33 as a valve member. The movable element 41 is provided with: an opening/closing surface 42 facing the valve seat 36; and a contact surface 43 opposite to the opening/closing surface 42 and facing the opposite end surface 31, and a seal member 44 made of elastic material is provided to the opening/closing surface 42. As shown in FIGS. 1 and 2, a clearance 45 is formed between the movable element 41 and the inner circumferential surface of the spacer 11b. The clearance 45 is communicated with the input ports 16a and 16b. Therefore, when compressed air is supplied to the input ports 16a and 16b under the state that driving current is not supplied to the coil 21, compressed air enters the valve chamber 33 through the clearance 45 and further enters a clearance between the contact surface 43 of the movable element 41 and the solenoid block 12. Then, the pressure of compressed air is applied to the contact surface 43 of the movable element 41. That is, a force in a direction toward the valve seat 36 is applied to the movable element 41. Thus, the output port 17 is closed by the movable element 41, and the flow of compressed air from the input ports 16a and 16b to the output port 17 is shut off so that the opening and closing valve 10 is closed.

On the other hand, when driving current is supplied to the coil 21, by a magnetic circuit formed in the fixed iron core 22 and the movable element 41, the movable element 41 is separated from the valve seat 36 and moved toward the magnetic attraction surface 32 of the fixed iron core 22. Therefore, the output port 17 is released to make the opening and closing valve 10 opened, and compressed air is supplied from the input ports 16a and 16b toward the output port 17.

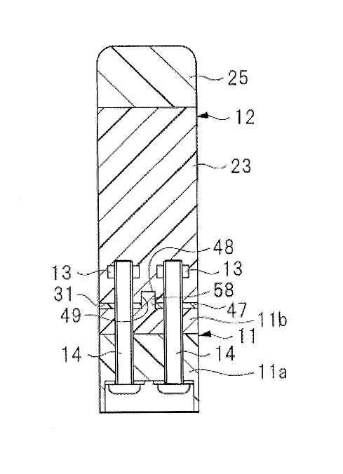

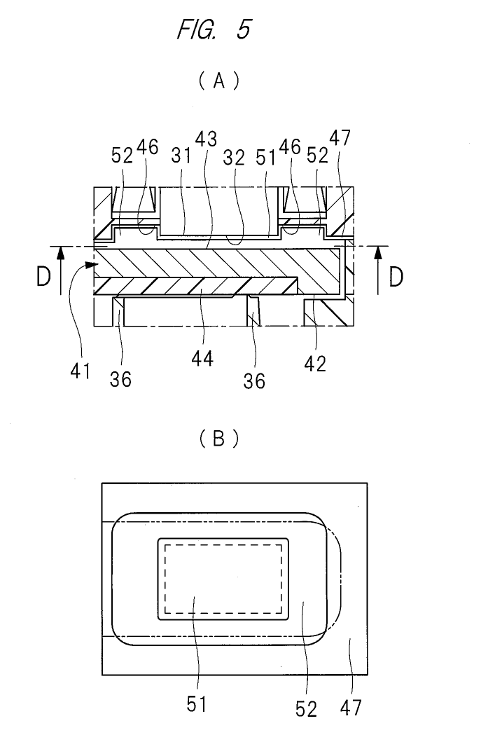

As shown in FIG. 5(A), a concave portion 46 is provided to the opposite end surface 31 of the solenoid block 12. As shown in FIG. 3, the concave portion 46 is formed into an annular shape on the opposite end surface 31 in a manner so as to surround each of the magnetic attraction surfaces 32. Additionally, in FIG. 3, a two dot chain line indicates the outside shape of the movable element 41, and when driving current is supplied to the coil 21, the movable element 41 is made in contact with a place indicated by the two dot chain line.

The concave portion 46 is formed into the annular shape on the opposite end surface 31 so as to surround each of the magnetic attraction surfaces 32 in FIG. 3. However, the shape of the concave portion 46 is neither intended to be limited by the shape surrounding the magnetic attraction surface 32, nor intended to be limited by the annular shape.

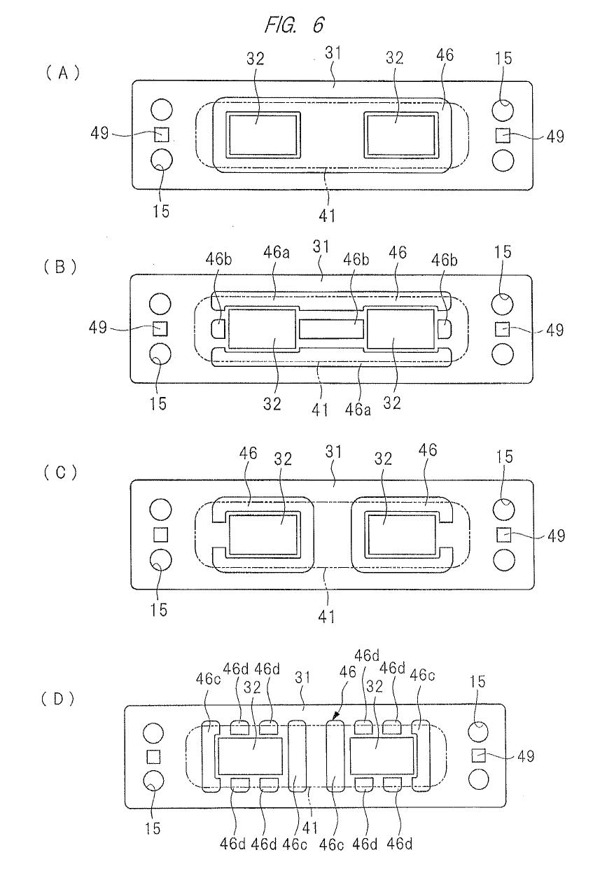

FIGS. 6(A) to 6(D) are bottom views of the solenoid block 12 that indicate modified examples of the concave portions 46 provided to the opposite end surface 31. The concave portions 46 shown in FIG. 6(A) have such a shape that the concave portions 46 shown in FIG. 3 are integrally connected to each other so as to surround the magnetic attraction surfaces 32. The concave portions 46 shown in FIG. 6(B) are provided with portions 46a that extend along the respective long sides of each magnetic attraction surface 32 and portions 46b that are located close to the ends (short sides) of the magnetic attraction surfaces 32. Each of concave portions 46 shown in FIG. 6(C) is formed into a C-letter shape on the outside of the magnetic attraction surface 32. Moreover, concave portions 46 shown in FIG. 6(D) is provided with a straight portions 46c that extend along the short sides of each magnetic attraction surface 32, and spot-like portions 46d that are arranged along the long sides of the magnetic attraction surface 32. As shown in FIG. 6, the concave portion 46 may have a shape that does not surround the magnetic attraction surface 32, and the concave portion 46 may have a straight-line shape or a C-letter shape.

In this manner, the concave portion 46 may at least partially face the movable element 41, and the remaining portion of the concave portion 46 that does not face the movable element 41 are not covered with the movable element 41 even when driving current is supplied to the coil 21 so that the movable element 41 is attracted toward the fixed iron core 22.

A sheet 47 made of resin is sandwiched between the valve body 11 and the solenoid block 12, and the sheet 47 is attached to the opposite end surface 31. In order to position-determine that the sheet 47 is disposed between the valve body 11 and the solenoid block 12, a positioning protrusion 48 is provided to the spacer 11b as shown in FIG. 4, and a positioning hole 49 into which the positioning protrusion 48 is inserted is provided to the solenoid block 12, as shown in FIG. 3. A positioning hole 58 is provided to the sheet 47 so as to correspond to the positioning protrusion 48 and the positioning hole 49. The sheet 47, which has a plane shape, is position-determined by the positioning protrusion 48 and the positioning hole 49 without using an adhesive, and sandwiched between the valve body 11 and the solenoid block 12. When the sheet 47 is sandwiched between the valve body 11 and the solenoid block 12, the sheet 47 is attached to the opposite end surface 31 so as to be made in contact with the opposite end surface 31. By attaching the sheet 47 to the opposite end surface 31, the opposite end surface 31 including the magnetic attraction surface 32 and the concave portion 46 is covered with the sheet 47.

When compressed air is supplied to the input port 16a of the assembled opening and closing valve 10, by the pressure of compressed air, a force in an expanding direction is applied to the valve chamber 33. By this force, the sheet 47 is adhered to the solenoid block 12 so that the sheet 47 located at the position corresponding to the concave portion 46 is deformed toward the bottom portion of the concave portion 46. As a result, the sheet 47 partially enters the concave portion 46, and is made in contact with the bottom portion of the concave portion 46. FIG. 5(A) partially shows the opening and closing valve with the sheet 47 deformed toward the bottom portion of the concave portion 46. In this manner, an air chamber 52 having a shape corresponding to the concave portion 46 is formed on the same side of the sheet 47 as the movable element 41. The deformed sheet 47 has a coated layer 51 that covers the magnetic attraction surface 32 and the concave portion 46.

The air chamber 52 having a shape corresponding to the concave portion 46 is not covered with the movable element 41 even when driving current is supplied to the coil 21 so that the movable element 41 is attracted by the fixed iron core 22. Therefore, even when the movable element 41 is attracted by the fixed iron core 22, the air chamber 52 is communicated with the input flow path 34 through the valve chamber 33. Therefore, the pressure of compressed air is applied to the surface of the movable element 41 that faces the air chamber 52. Since the pressure of compressed air is also applied to the surface of the movable element 41 that faces the valve seat 36, forces onto the two members are canceled per unit area.

In the drawings, the concave portion 46 and the sheet 47 are indicated in an exaggerated manner. The depth of the concave portion 46 is set to, for example, 200 to 500 μm, and the thickness of the sheet 47 is set to, for example, 30 to 100 μm.

In this manner, since the opposite end surface 31 of the solenoid block 12 is covered with the sheet 47, compressed air flowing into the valve chamber 33 from the input ports 16a and 16b is prevented from being made in contact with the magnetic attraction surface 32 of the fixed iron core 22. Therefore, the magnetic attraction surface 32 is prevented from being corroded by moisture contained in compressed air, thereby making it possible to maintain the opening/closing operation characteristics of the movable element 41 with high precision for a long period of time. Thus, the durability of the opening and closing valve 10 can be improved.

Moreover, when driving current is supplied to the coil 21, the movable element 41 is released and moved toward the magnetic attraction surface 32, and the movable element 41 is made in contact with the sheet 47 except for portions entering the concave portions 46, without the entire contact surface 43 of the movable element 41 being made in contact with the sheet 47. Moreover, even after the movable element 41 has been released and moved toward the magnetic attraction surface 32 to be made in contact therewith, since the air chamber 52 is communicated with the input flow path 34, it is kept in a state filled with compressed air. Therefore, with respect to the movable element 41, immediately after it stops supplying a driving current to the coil 21, the pressure on the opening/closing surface 42 that faces the output port 17 is first lowered, while the pressure on the contact surface 43 which faces the magnetic attraction surface 32 and at which the air chamber 52 is located is kept high. That is, by a difference between a force applied to the opening/closing surface 42 and a force applied to the contact surface 43, the movable element 41 is pushed toward the valve seat 36. Although time in which the difference between the two forces is exerted is short, the time is long enough to push the movable element 41 toward the valve seat 36. In this manner, by the force of compressed air inside the air chamber 52, the movable element 41 is quickly separated from the coated layer 51 and moved toward the valve seat 36. Thus, closing operation time in which the movable element 41 is separated from the fixed iron core and closes the valve seat can be shortened. The above-mentioned effect is remarkably exerted in an opening and closing valve in which the operation frequency of about 50 times to 400 times per second is required.

Moreover, the sheet 47 is sandwiched between the opposite end surface 31 of the solenoid block 12 and the valve body 11. Therefore, the sheet 47 is attached to the opposite end surface 31 of the solenoid block 12 without using an adhesive, and without thickness of the adhesive. Consequently, the magnetic attraction surface 32 can be covered only by using the thin sheet 47. Thus, the distance between the movable element 41 and the fixed iron core 22 can be shortened. Therefore, a large magnetic force is not required for the coil so that it is not necessary to make the coil 21 larger, thereby making it possible to downsize the opening and closing valve. Moreover, when driving currently is supplied to the coil 21, since the movable element 41 is allowed to move toward the fixed iron core 22 in a short period of time, the responsiveness of the movable element 41 can be improved.

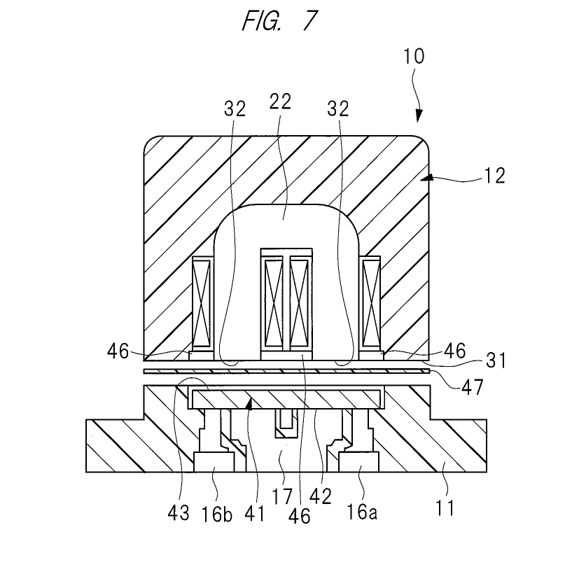

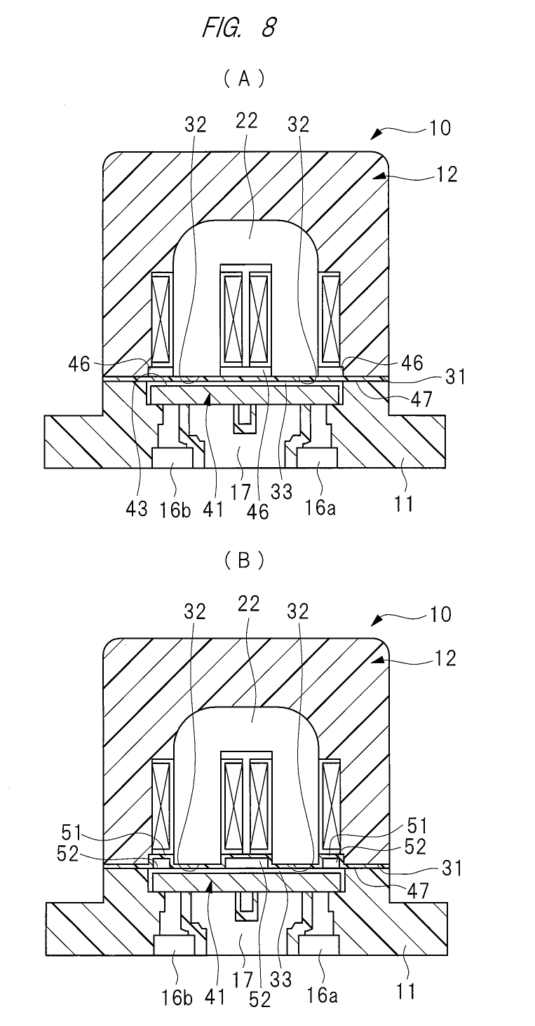

FIG. 7 is a cross-sectional view that schematically shows a state in which a sheet made of resin is disposed between the valve body 11 and the solenoid block 12 with clearances. FIGS. 8 to 10 are schematic cross-sectional views showing an attaching method for attaching the sheet 47 to the opposite end surface 31 of each of solenoid blocks 12. In FIGS. 7 to 10, the depth of the concave portion 46 and the thickness of the sheet 47 are indicated in an exaggerated manner.

The sheet 47 is attached to the entire surface of the opposite end surface 31 of the solenoid block 12. Therefore, compressed air supplied to the valve chamber 33 is prevented from entering the solenoid block 12. Thus, it becomes not necessary to dispose a seal member or the like for use in maintaining airtightness inside the solenoid block 12. Moreover, since the sheet 47 is sandwiched between the valve body 11 and the solenoid block 12, the sheet 47 is allowed to seal the clearance between the valve body 11 and the solenoid block 12. Therefore, it becomes not necessary to dispose a seal member or the like for use in maintaining airtightness between the valve body 11 and the solenoid block 12.

As one example of the attaching method of the sheet 47, the opening and closing valve 10 is assembled as shown in FIG. 8(A). Thus, the sheet 47 is sandwiched between the valve body 11 and the opposite end surface 31 of the solenoid block 12. Under this state, compressed air is supplied to one or both of the input ports 16a and 16b. Compressed air supplied to the input port is allowed to flow into the valve chamber 33 through the clearance 45. When compressed air flows into the valve chamber 33, the sheet 47 is deformed by compressed air flowing into the space between the contact surface 43 of the movable element 41 and the sheet 47 so that the sheet 47 enters the concave portion 46 in accordance with the inner surface shape of the concave portion 46. Thus, as shown in FIG. 8(B), the magnetic attraction surface 32 is covered with a portion of the coated layer 51 of the sheet 47. Moreover, the inner surface of the concave portion 46 is covered with the deformed portion of the sheet 47 so that an air chamber 52 is formed by the sheet 47.

In this attaching method, after the opening and closing valve 10 is assembled, by supplying compressed air into the valve chamber 33, the sheet 47 can be deformed into a shape corresponding to the patterned indented opposite end surface 31. However, without assembling the opening and closing valve 10 by using the screw members 14, the sheet 47 may be brought into a temporary assembled state between the valve body 11 and the solenoid block 12, and compressed air may be supplied into the valve chamber 33.

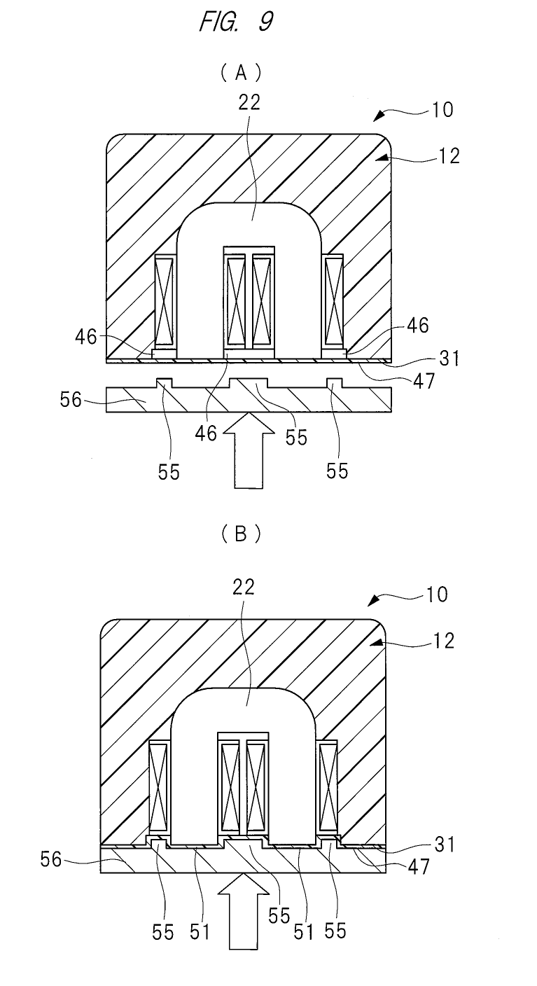

In the attaching method of the sheet 47 shown in FIG. 9, a forming mold 56 in which a protrusion 55 that enters the concave portion 46 is formed is used. The forming mold 56 is formed by a hard resin or metal, and has a rectangular molding face corresponding to the patterned indented opposite end surface 31. Upon attaching the sheet 47 to the solenoid block 12, in a state in which the sheet 47 is made in contact with the opposite end surface 31 of the solenoid block 12, the forming mold 56 is pressed onto the solenoid block 12. Thus, as shown in FIG. 9(B), the protrusion 55 is brought to such a state as to enter the concave portion 46 with the interposed sheet 47. When the forming mold 56 is pressed onto the solenoid block 12, the magnetic attraction surface 32 is covered with the coated layer 51 of the sheet 47. Moreover, the inner surface of the concave portion 46 is covered with the deformed portion of the sheet 47 so that the air chamber 52 is formed by the sheet 47. In this manner, the forming mold 56 in which only the protrusion 55 is formed by using elastic member such as rubber may be used.

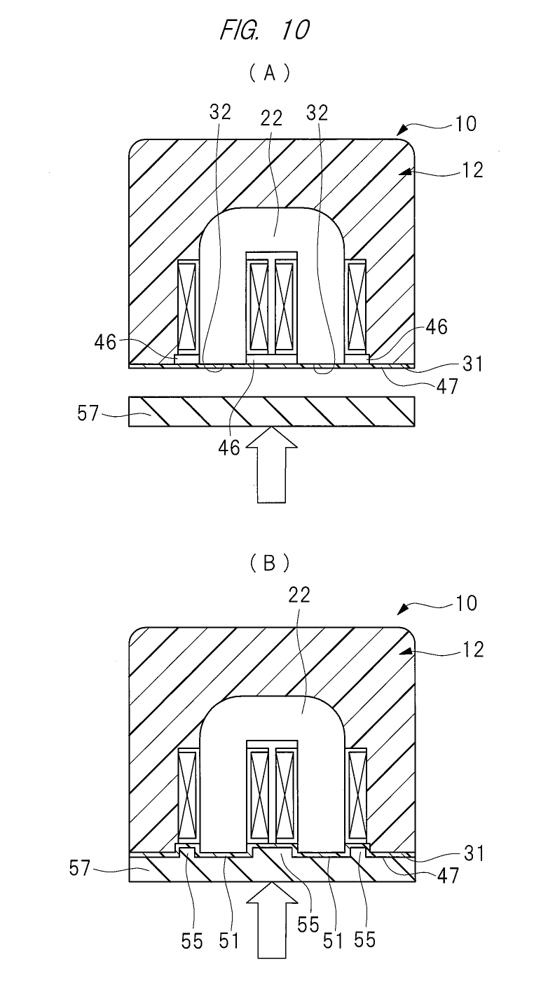

In the attaching method of the sheet 47 shown in FIG. 10, the elastic member 57 such as rubber or the like is used. The elastic member 57 has a rectangular molding face corresponding to the opposite end surface 31. In order to attach the sheet 47 to the solenoid block 12, under a state in which the sheet 47 is made in contact with the opposite end surface 31 of the solenoid block 12, the elastic member 57 is pressed onto the solenoid block 12. Thus, as shown in FIG. 10(B), a portion of the elastic member 57 corresponding to the concave portion 46 is elastically deformed so as to enter the concave portion 46 with the interposed sheet 47. When the elastic member 57 is pressed onto the solenoid block 12, the magnetic attraction surface 32 is covered with the coated layer 51 of the sheet 47. Moreover, the inner surface of the concave portion 46 is covered with the deformed portion of the sheet 47 so that the air chamber 52 is formed by the sheet 47. When the sheet 47 is attached to the solenoid block 12 by the elastic member 57, a protrusion may be provided to the elastic member 57, as shown in FIG. 9.

As shown in FIGS. 8(A) to 10(B), by deforming one portion of the sheet 47 so as to enter the concave portion 46, the sheet 47 is formed so as to correspond to the patterned indented opposite end surface 31 so that the sheet 47 can be positively attached to the opposite end surface 31, without attaching the sheet 47 to the opposite end surface 31 by using an adhesive. Thus, the magnetic attraction surface 32 can be covered only by the thin sheet 47, with the thickness of the adhesive being eliminated, and the air chamber 52 can also be formed. Since the magnetic attraction surface 32 can be covered with the thin sheet 47, the distance between the movable element 41 and the fixed iron core 22 is shortened. Therefore, the responsiveness of the movable element 41 can be improved in this valve.

Additionally, in FIGS. 1 and 5, although the seal member 44 is provided to the surface of the movable element 41 that faces the valve seat 36, the flat face of the movable element 41 may directly face the valve seat 36 without the seal member 44. In this case, the flat face of the movable element 41 is made in contact with the valve seat 36 so as to close the valve.

Moreover, the magnetic attraction surface 32 of the fixed iron core 22 may be covered with a thin resin, without being exposed onto the opposite end surface 31. In this case also, since the thickness of an adhesive can be eliminated, the distance between the movable element 41 and the fixed iron core 22 is shortened. Therefore, the responsiveness of the movable element 41 can be improved.

This opening and closing valve 10 is applicable to an air pressure system for supplying compressed air supplied from an air pressure source to a specific member.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An opening and closing valve comprising:
a valve body provided with a valve seat;
a solenoid block that forms a valve chamber in cooperation with the valve body;
an opposite end surface on which a magnetic attraction surface of a fixed iron core around which a coil is wound is provided, and which is provided to the solenoid block so as to face the valve body;
a movable element provided in the valve chamber, wherein the movable element is attracted to the magnetic attraction surface when driving current is supplied to the coil;
a concave portion that is provided to the opposite end surface, at least one portion thereof facing the movable element; and
a sheet made of resin and attached to the opposite end surface so as to cover the magnetic attraction surface and the concave portion,
wherein an air chamber is formed by the sheet and the concave portion.

2. The opening and closing valve according to claim 1, wherein the magnetic attraction surface is exposed on the opposite end surface, and covered with the sheet made of resin.

3. The opening and closing valve according to claim 1,
wherein the sheet is sandwiched between the valve body and the solenoid block.

4. The opening and closing valve according to claim 3, wherein the sheet is formed with a positioning hole into which a positioning protrusion is inserted.

5. The opening and closing valve according to claim 1, wherein the sheet attached between the valve body and the solenoid block is deformed by compressed air supplied to the valve chamber so that the air chamber is formed.

6. The opening and closing valve according to claim 1, wherein the sheet made in contact with the opposite end surface of the solenoid block is deformed by using a forming mold having a protrusion that is inserted into the concave portion so that the air chamber is formed.

7. The opening and closing valve according to claim 1, wherein the sheet made in contact with the opposite end surface of the solenoid block is deformed by elastic member so that the air chamber is formed in the concave portion.
